(19) United States
(12) Patent Application Publication
(10) Pub. No.: US 2011/0153564 A1
(43) Pub. Date: Jun. 23, 2011

(54) ERROR-SENSITIVE ELECTRONIC DIRECTORY SYNCHRONIZATION SYSTEM AND METHODS

(75) Inventors: Munir Cochinwala, Basking Ridge, NJ (US); Adam Drobot, Bernardsville, NJ (US); Ashish Jain, Bridgewater, NJ (US); John R. Wullert, II, Martinsville, NJ (US)

(73) Assignee: TELCORDIA TECHNOLOGIES, INC., Piscataway, NJ (US)

(21) Appl. No.: 12/645,524

(22) Filed: Dec. 23, 2009

(51) Int. Cl. G06F 17/30

(52) U.S. Cl. 707/624; 707/E17.005; 707/610

(57) ABSTRACT

A system and method is provided for synchronizing related entries in different electronically stored directories. In one implementation, the method includes the steps of: storing first entries in a first directory, one of a plurality of directories, the first entries having first fields for different types of information and each first field having a related stored confidence level indicating the degree of confidence of the accuracy of the data stored in each first field; storing second entries in related second fields in a second memory, each of the second field entries having a corresponding stored confidence level; determining when a change has been made to a field of an entry; and updating the corresponding field in the other directory with a confidence level for the field when a change exceeds a threshold.

### BACKGROUND

1. Technical Field

The systems and methods disclosed herein relate to the field of synchronizing related entries in different electronically stored directories and, more specifically, to systems and methods of accommodating for potential errors as changes are made to those directories.

2. Description of the Related Art

People today have different means of communication. Many of these communication methods are facilitated by computerized terminal devices, such as cellular telephones and personal computers. These so-called intelligent terminals often provide electronic directories, allowing users to store the names, profiles, various addresses, and phone numbers for people they contact regularly. Discrepancies can arise between these directories, where the information does not match. Such discrepancies can be the result of users making changes to the directory information in one device without making the corresponding changes to the directory information in the other devices.

There are systems that can provide synchronization between these disparate directories. Such systems can synchronize additions as well. Changes to existing records can be synchronized based on time stamps, assuming the last changed record is correct, or user configuration, wherein one directory is deemed to be the master directory. These mechanisms work well in cases where the data used to update the directories can be assumed to be correct.

The present inventors have devised automated means of updating these directories by parsing voicemail messages or real-time voice communications to extract the information. See, for example, the copending application entitled, “Automated Extraction of Information from Ongoing Voice Communications,” Ser. No. ______, filed ______, and the copending application entitled, “Automated Directory Updates from Voicemail,” Ser. No. ______, filed ______. The content of these two applications is hereby expressly incorporated by reference.

When directories are updated by automated means, based on information extracted using speech recognition or other means subject to errors, there is a possibility that the updates will insert errors into the directory. The existing synchronization mechanisms are likely to simply propagate such errors, potentially overwriting all copies of the correct information. Thus, there is a need for a system that can perform such synchronization in the face of errors in the directory data.

### SUMMARY

In one embodiment, a method for synchronizing related entries in different electronically stored directories is provided. This method includes the steps of storing first entries for a first one of the directories in a first memory, these first entries having first fields for different types of information, and each first field having a related stored confidence level indicating a degree of confidence of the accuracy of the data stored in each first field. This method further includes storing second entries for a second one of the directories in a second memory, these second entries corresponding to the stored first entries of the first directory, and these second entries having second fields for different types of information, each second field corresponding to a first field in a related first entry and each second field having a stored confidence level indicating a degree of confidence of the accuracy of the data stored in each second field.

In this one embodiment, the method further includes determining when a change has been made to a field of an entry and updating the corresponding field in the other directory when the confidence level for said field exceeds a threshold. This threshold may, for example, be pre-assigned independent of the stored confidence level of any field, or may, for example, comprise the confidence level of the field in the other directory to be changed.

Consistent with another embodiment, a method of synchronizing related entries in different electronically stored directories is provided comprising the steps of receiving a proposed change in a field of one entry for one of the directories; determining the confidence level of the proposed change, this confidence level indicating a degree of confidence of the accuracy of the data in the proposed change; storing, in a memory device, the proposed field change and confidence level for the field of the one entry in the one directory; and synchronizing a corresponding field in at least one related entry in at least another one of the directories based on the confidence level for the one field.

In another embodiment, the method of synchronizing related entries in different electronically stored directories comprises the steps of periodically comparing hash entry values of the related entries in the different directories; identifying at least one changed field in one of the related entries in one of the directories when hash values for the related entries in the different directories are not the same; identifying a most recently changed field in the related entries corresponding to the one changed field when the hash entry values are different for related entries; identifying a confidence level stored in a memory for the identified most recent changed field, the confidence level indicating a degree of confidence of the accuracy of data stored in the most recent changed field; and synchronizing the fields in the related entries corresponding to the one changed field in at least another one of the directories based on the confidence level for the one field.

The present invention may also take the form of a system for synchronizing related entries in different electronically stored directories, comprising, in one embodiment, a first memory storing first entries for a first one of the directories, the first entries having first fields for different types of information, and each first field having a related stored confidence level; a second memory storing second entries for a second one of the directories corresponding to the stored first entries of the first directory, the second entries having second fields for different types of information, each second field corresponding to a first field in a related first entry and each second field having a stored confidence level; and a processor connected to communicate with the first and second memories, and programmed to determine when a change has been made to a field of an entry and to update the corresponding field in the other directory when the confidence level for the changed field exceeds a threshold.

Still further, the invention may take the form of a directory for use with a system for synchronizing related entries in different electronically stored directories, that directory comprising, for example, a memory storing first entries for that directory, these first entries having fields for different types of information, and each field having a related stored confidence level that indicates a degree of confidence of the accuracy of the data stored in that field.

It is important to understand that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate various embodiments. In the drawings:

FIG. 1 is a block diagram illustrating a system for synchronizing related entries in different electronic directories, consistent with one embodiment of the invention.

FIG. 2 is an example of the contents of an electronic directory entry of the present invention.

FIG. 3 is a flow diagram of one embodiment of a method of the present invention.

FIG. 4 is a flow diagram of one embodiment of a verification procedure of the present invention.

FIG. 5 is a flow diagram of one embodiment of a “questionable data” procedure of the present invention.

FIG. 6 is a flow diagram of one embodiment of an “update all entries” procedure of the present invention.

FIG. 7 is another example of the contents of an electronic directory entry of the present invention.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings. Whenever possible, the same reference numbers will be used throughout the drawings to refer to the same or like parts.

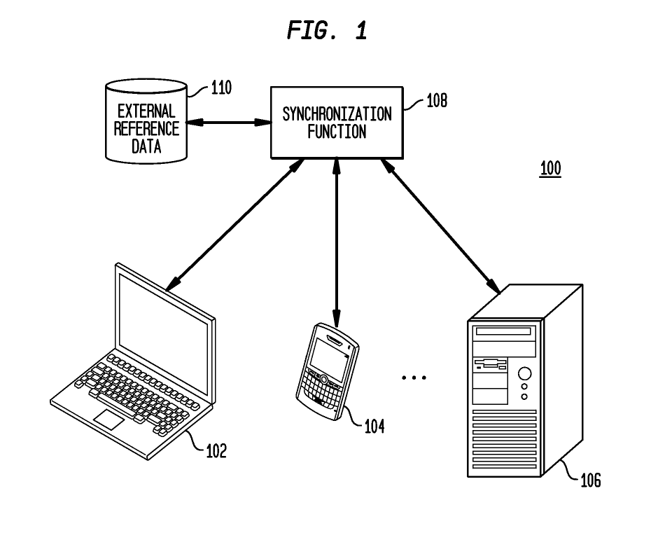

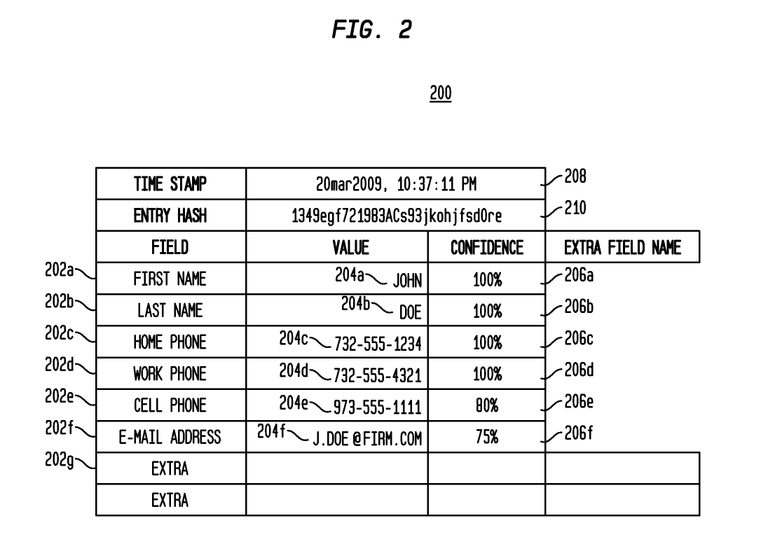

FIG. 1 illustrates a system 100 for synchronizing related entries in different electronically stored directories. For example, there is illustrated in FIG. 1 a personal computer 102, a cell phone 104, and a server 106, each of which have their own electronic directory. Each of these directories includes a memory for storing entries that may, for example, include contact information. As is shown in more detail in FIG. 2, each entry 200 of the directory may include a plurality of fields 202a-202f that include information, such as first names, last names, home telephone numbers, work telephone numbers, cell phone numbers, and/or e-mail addresses. Each field 202a-202f of entry 200 also includes a value 204a-204f associated with that field. As noted above, values 204a-204f may include names, telephone numbers, and addresses, such as e-mail addresses, residential addresses, commercial addresses, or the like.

In accordance with one aspect of the present invention, each field 202a-202f also has a related stored confidence level 206a-206f that indicates a degree of confidence in the accuracy of the data stored in that field. As is shown in FIG. 2, confidence levels 206a-206f are stored for each field 202a-202f of entry 200. The selection of the values for confidence levels 206a-206f is set out below.

Each entry 200 also preferably includes a time stamp 208 and a hash entry 210. It should be apparent to one of ordinary skill in the art that time stamp 208 of each entry 200 indicates the date and time of the most recent update of entry 200. Hash entry 210 is developed according to conventional techniques to identify where there has been a change in the information or confidence level 206a-206f contained in any of the respective fields 202a-202f of entry 200.

Returning to FIG. 1, a processor 108 with a synchronization function is connected to communicate with the memories of personal computer 102, cell phone 104, and server 106. This communication may occur by any conventional methodology, including landline, Internet, radio communication, or the like. As will be discussed in more detail below, processor 108 is preferably programmed to determine when a change has been made to a field and to update the corresponding field of any related entries in the other directories when the confidence level for that changed field exceeds a threshold.

More specifically, the purpose of the synchronization function in processor 108 is to collect data from the various directories, reconcile that data, and then update those directories with the most recent and most accurate data. The synchronization function of processor 108 is also connected to one or more sources of external reference data 110, as is also shown in FIG. 1. This external reference data 110 could include online telephone books, the Internet domain name system, and other such sources of data that can be used to verify user information.

The electronic directories contained in various devices, for example, personal computer 102, cell phone 104, and server 106, as noted above, contain entries representing user contacts. These entries contain relevant contact information, such as name, address, various phone numbers (e.g., home, work, cell), and e-mail addresses. To facilitate synchronization, the following information is also contained in these electronic directories:
a time stamp and/or a hash entry that will allow tracking and comparison of the order of changes in different electronic directories;
a confidence level on each entry in the electronic directory; and
extra fields that are not predefined, which can be used for storing values that have not been confirmed to be accurate. These records would include the ability to specify the type of value stored therein. Alternatively, there could be an extra version of each of the predefined fields.

As was noted above, FIG. 2 shows an example of an electronic directory entry 200. These entries can be entered into the directories in a variety of ways. The information might simply be typed by the user using a computer keyboard. The information might be received in a message, such as an e-mail, and entered into the directory by means of a “cut and paste” operation. The information might be entered through the keypad of a cellular phone. Information might be entered through a speech-recognition system that is either built into a computing device or is part of the directory update service. As noted above, a copending application entitled, “Automated Extraction of Information from Ongoing Voice Communications,” Ser. No. ______, filed ______, and a copending application entitled, “Automated Directory Updates from Voicemail,” Ser. No. ______, filed ______, disclose methodologies for how directory information can be extracted from voicemail messages or telephone conversations and asserted automatically into electronic directory entries. The information could be entered using a stylus and a touchscreen on a personal digital assistant device.

Each of these input mechanisms has its own characteristic error rates. Users entering data via a keypad or cellular telephone, where they must press a key one or more times to get the correct letter, are more likely to make mistakes than users entering data via a standard QWERTY keyboard. In addition, people are more likely to catch an entry mistake when it is reviewed on a full-size computer screen than when seen on a two-inch-square cellular telephone screen. Speech-recognition systems, which attempt to translate audio to text through a matching process, cannot recognize spoken phrases accurately in all situations. In fact, such systems often report a confidence level ranking with the proposed text to indicate the degree to which the recognition engine expects that the text represents the spoken phrase.

Inventors have discovered that this concept of a confidence ranking can be applied with beneficial effect in the process of synchronizing electronic directories. It is possible to assign a confidence level to field entry data that has been input into a particular electronic directory through a specific methodology. The confidence level assigned based upon that methodology provides an indication of the overall expectation of error rate.

For example, typed entries might be assigned a 95% confidence level, touchscreen entries may be assigned a 90% confidence level, and keypad entries may be assigned an 85% confidence level.

The confidence level values could also be assigned adaptively. For example, the confidence level for a given field could be adjusted based on the number of characters contained in the information for that field. The greater the number of characters, the lower the confidence level. For example, with the addition of each new character, the previous confidence level could be reduced by multiplying by a factor of 99.9%.

The confidence level might also be adjusted based on the technology that was used to collect the data. If the system has performed a spell-checking operation, the confidence level might be increased. The magnitude of such an increase might vary, depending upon whether the user or the system performed the correction, thereby taking into account the fact that automated, system-performed corrections might make a mistake and the chance that such a mistake has in fact occurred.

The confidence level might also be varied with the type of entry being submitted. Given the need to include letters, numbers, and punctuation marks, the error rate for entering e-mail addresses could be higher than for other entries, and, thus, these might receive a lower confidence level for a given input type.

From these types of operations, it is possible to attain a measure of the confidence in the correctness of the value for each field in a directory and to include that information within the directory associated with each field. Although directory applications might not make this information visible to users, it should be appreciated to one of ordinary skill in the art, given the inventors' disclosure herein, that the information may be exploited as part of the synchronization operation. Alternatively, directory applications could make the confidence levels visible to the user and, therefore, make them user adjustable. This would be useful in cases where users are entering data that they are not sure is correct. The system can then handle this uncertainty, as described below.

One key to the invention, accordingly, is the use of confidence level information in conjunction with time stamps and/or hash information that is generally used to produce synchronized directories with a high probability of being correct, even when the accuracy of individual entries is questionable.

The synchronization function of the present invention can be triggered to execute in a variety of fashions. It might operate on a periodic basis, such as running every night at 2:00 a.m. or every Monday at 8:30 a.m. Alternatively, it might be triggered by the request from one of the electronic directories. The request might be triggered based upon a specific user request to synchronize or it might be an automated response to an update of the directory.

When the synchronization function is triggered, it collects the relevant directory entries from the electronic directories. If the synchronization function is triggered to perform a full comparison of all the electronic directories, it retrieves all the entries from each electronic directory. If the synchronization function is triggered to perform updates across all electronic directories as the result of an update to a single entry in one of the directories, it retrieves the corresponding entries from the other directories.

After the synchronization function has retrieved the relevant entries from the electronic directories, it compares the corresponding entries in the various electronic devices. Rather than simply assuming the latest entry is correct or assuming one directory is consistently more reliable than another master directory, the synchronization function of the present invention uses the confidence level information to ensure that the entries with high uncertainty are not used to overwrite other data.

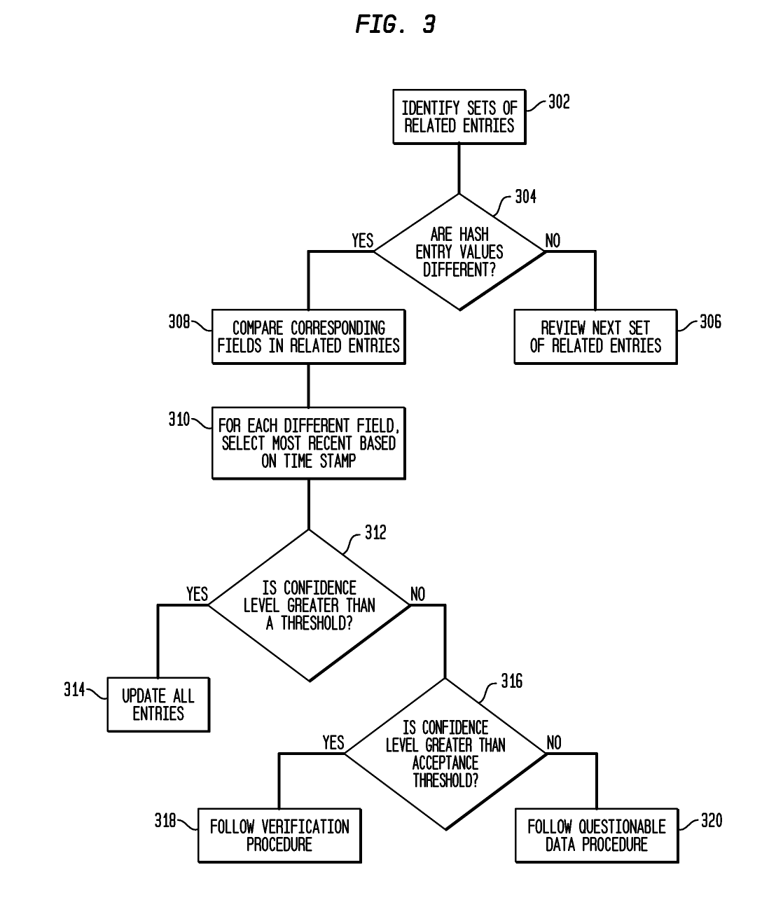

One example of a flow diagram for an embodiment of the synchronization function of the present invention is shown in FIG. 3. The first step 302 is to identify sets of related entries in the various electronic directories of the devices contained in the system. A set of related entries may, for example, comprise entries with the same individual's name, the same company, the same event or undertaking, or the like. Thus, if the telephone and address information for John Smith appears in more than one directory, the entries in each directory associated with John Smith comprise a set of related entries. Related entries may be identified using, for example, fuzzy logic, or they may simply be identified by the user as being related. To facilitate identification of sets of related entries, each related entry of a set may have a common indicator to signify that it is in fact a member of a particular set of related entries.

The second step 304 inquires as to whether the hash entry values for these sets of related entries are different. Presumably, related entries will have identical content if the directories are perfectly synchronized, since the hash entry values are dependent upon the content of the entry. To the contrary, if related entries have different content, their hash values will be different, necessitating a preferred embodiment, the undertaking of a synchronization procedure. Thus, as shown in FIG. 3, if the step 304 of determining if hash entry values are different results in a negative determination, step 306 is next undertaken, which simply requires a review of the next set of related entries.

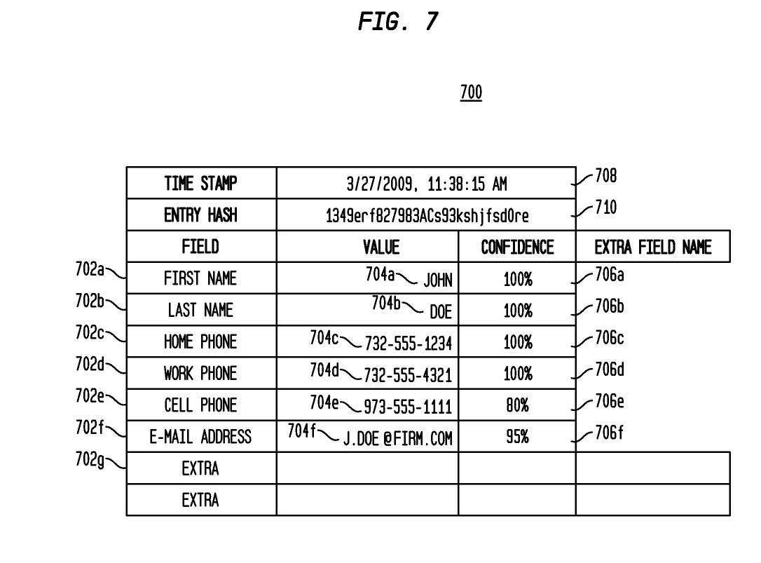

If, however, step 304 of determining if hash entry values are different results in a positive determination, step 308 is executed, which comprises the act of comparing corresponding fields in the related entries for which hash values have been determined to be different. By way of example, if a set of related entries comprises the entries of FIGS. 2 and 7, we see that the first and last names of these two entries are identical, which may be a basis for determining that they are in a related set. However we see that hash entry value 210 of the FIG. 2 entry 200 is different than the hash entry value 710 of the FIG. 7 entry 700, indicating that the two entries have different content. Thus, in step 304 of FIG. 3, a positive “yes” determination would result in execution of step 308, thereby comparing fields 202a-202f of the FIG. 2 entry 200 with corresponding fields 702a-702f of the FIG. 7 entry 700. From this activity, it will be determined in the given example that the e-mail address 704f of field 702f of the FIG. 7 entry 700 is different from the e-mail address 204f of field 202f of the FIG. 2 entry 200. This has resulted in the different hash entry values 210 and 710.

The next step 310 of the FIG. 3 process requires that for each different field, the most recent field must be selected, preferably based upon a time stamp entry. Referring back to FIGS. 2 and 7, there is a time stamp entry 208 and 708 for each of the related entries, the time stamp entry 708 being more recent, thereby indicating that the field entry 702f is more recent than the field entry 202f. Alternatively, each entry may keep track of a time stamp for each of the fields as they are entered or updated, thereby providing an alternative methodology by which, for each different field, the most recent entry may be selected among the corresponding fields of the related entries that have been determined to have different values.

As is next shown in step 312 of FIG. 3, a determination is made as to which confidence level is greater than a threshold. This may be a predetermined threshold, also referred to as an “approval threshold,” having a particular level deemed sufficient to rely upon the information, or it may be adaptively adjusted to be the highest of the confidence levels of the same corresponding fields in any other directory to be changed by the synchronization process.

Assuming, for example, an approval threshold of 80%, in the case of the FIG. 7 changed field, which is shown to have an 85% confidence level 706f, a positive determination will result that confidence level 706f is sufficiently great to justify an update of all entries. In this case, as is shown by step 314 of FIG. 3, all of the corresponding fields of the related entries would be updated with the 704f e-mail address J.Doe@firm.com (shown in FIG. 7), thereby presumably correcting the e-mail address 204f, J.Dae@firm.com (shown in FIG. 2), which is presumed to have a lower likelihood of being accurate.

If, however, only the confidence level of the changed field is tested against an absolute threshold, it is possible that the changed entry may have a confidence level sufficiently high to justify changing the corresponding fields, but lower than the confidence level of one or more of the field entries to be synchronized. In this event, there are two alternatives. One may choose to set the system so that the new confidence level is used in all corresponding entries, thereby allowing a higher confidence level to be lowered.

In the alternative, the system may be set to have the threshold level of step 312 of FIG. 3, instead of just being predetermined, comprise the highest confidence level of the corresponding fields. Thus, if the changed field confidence level were 85%, as shown in FIG. 7, but the confidence level of the corresponding field in related entry 202 were in fact 95% instead of 75%, as shown in FIG. 2, then all of the directories would be changed to include the e-mail value 204f of FIG. 2 rather than the e-mail value 704f of FIG. 7. This alternative, however, has the disadvantage of making it difficult to alter any entry with a preexisting high confidence level.

Returning now to the procedure of FIG. 3, if the confidence level of a changed field is determined to be less than the threshold of step 312, in a preferred embodiment, a still further inquiry of step 316 is undertaken to determine whether or not the confidence level, being less than the threshold of step 312, is nevertheless greater than an acceptance threshold of step 316. If the confidence level of the changed field is greater than the acceptance threshold of step 316, then step 318 is executed to follow a verification procedure. If the confidence level in step 316 is determined to be less than the acceptance level, then a questionable data procedure of step 320 is preferably followed.

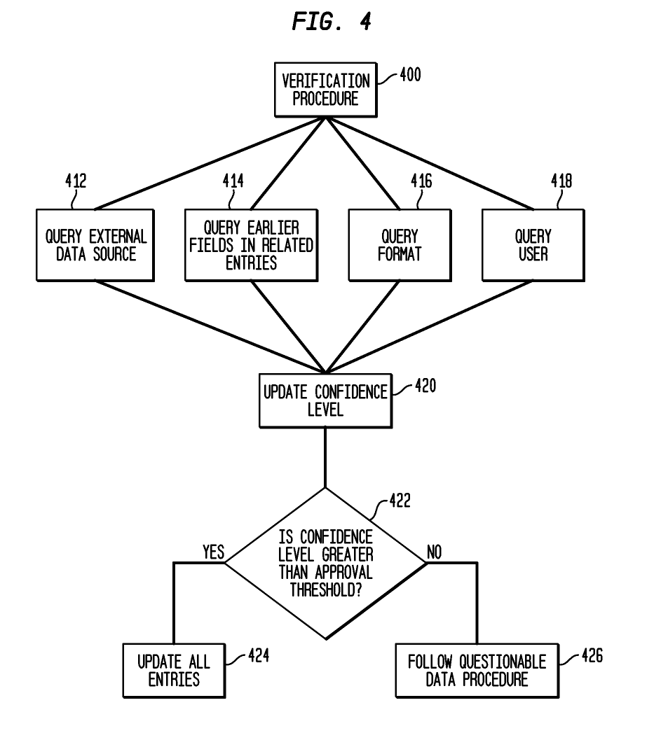

FIG. 4 illustrates a flow diagram of one embodiment of a verification procedure 400 that may be implemented after a positive determination in step 316 of FIG. 3. Specifically, new field entries with low confidence values may be tested and/or verified prior to performing any updates in an attempt to increase the confidence level or correct the data. These tests could include one or more of the following:
query of external data sources, as indicated by step 412 in FIG. 4. External data sources, such as online telephone directories, may be queried and compared to see if the entries with low confidence values match the values provided from these other external sources. If they do, the corresponding confidence level stored for that changed field value may be increased accordingly. Also, external data sources may be queried to determine if the value in the changed field represents a valid result for that field. For example, is the domain name in an e-mail address a registered value, or does the cell phone number correspond to a number range assigned to a cellular telephone company? If such an inquiry is positive, the confidence level stored for the changed field may be increased accordingly.
query earlier fields in related entries, as indicated by step 414 in FIG. 4. By comparing the changed field with entries in other directories, even those of the user or external sources, and calculating the amount of difference between the entries, it is possible to provide a more accurate confidence level value. If the entries are within a certain degree of similarity, the low confidence entry could be given a higher confidence value.
query the format, as indicated by step 416 in FIG. 4. Analyzing the changed field value as a function of the appropriateness of the format for that field can allow for an increase in the confidence value. For example, does a phone number entry match a domestic or international dialing plan? Does the format of the phone number (e.g., country code) agree with the address information stored for the individual? If so, a higher confidence value may be assigned. Likewise, if the e-mail address has a valid format, it may be afforded a higher confidence level value.
query the user, as indicated by step 418 in FIG. 4. Initiating an interaction with the user to get confirmation of the values being presented is another methodology by which the confidence level may be.

Based on the results of these verification and/or correction tests, the value of the confidence level may be increased in step 420 of FIG. 4. If the confidence level rating in the new entry is then high enough after this operation, for example, that it exceeds a defined threshold of the type of query in step 312 of FIG. 3, the value can be used to update other directories. If not, it does not necessarily imply that the value with the low confidence rating is incorrect. Thus, in step 422, a determination is made whether the new confidence level is greater than the approval threshold level of step 312. If so, all entries are updated with the changed field value in step 424. But if not, a questionable data procedure is followed in accordance with step 426.

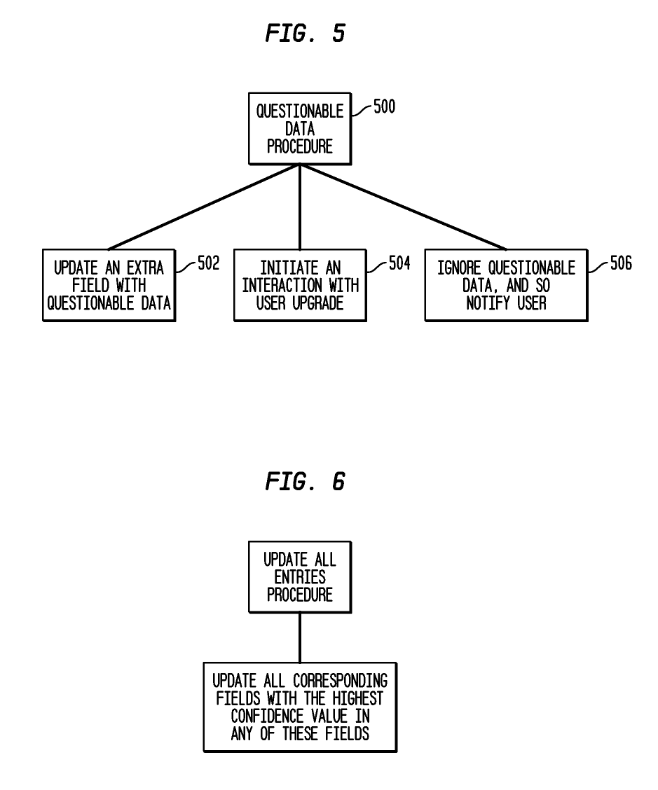

There are many reasons why a low confidence level may nevertheless be associated with a field value that justifies retention. For example, the changed field might be a friend's brand new telephone number that is not yet represented in an online directory, nor is it in the user's other directories. In this case, the synchronization function of the present invention can act on an entry to add an extra field as indicated, for example, by adding extra field 202g in FIGS. 2 and 702g in FIG. 7. The questionable data procedure 500 of FIG. 5 represents this action as step 502, wherein an extra field is updated with questionable data. With this feature, existing data is not overwritten, but possibly accurate data is not lost just because it has a low confidence level value. In the above example, if one directory has a new cellular telephone number with a low confidence level value, and the confidence in that number cannot be increased by the verification and/or correction tests, an extra entry may be created in each of the user's other directories. The low confidence cellular telephone number may be copied into that extra field. This ensures that the user has access to the information in each directory, in case it turns out that the new cellular telephone number is in fact of value.

Alternatively, the synchronization function of the present invention could leave the questionable field data in the one directory without propagating it to any other directory, and provide notification to the user, via e-mail, a host Message Service (“SMS”), or phone, of the discrepancy, thereby providing a means to correct or verify the low confidence entry. In this instance, however, it may be important that that hash entry value utilized to determine if there has been a change not be affected by this unilateral entry that has not been synchronized with other directories.

Thus, the questionable data procedure may include a step 504, similar to step 408 in FIG. 4 of the verification procedure, to initiate interaction with a user to determine if an upgrade of confidence level is appropriate.

Still another possibility indicated by step 506 of FIG. 5 is to ignore the questionable data, and so notify the user.

The programming that provides some or all of the functionality of FIGS. 3-6 may be stored on a computer-readable medium of processor 108 of FIG. 1, or it may be distributed between one or more electronic devices, for example, personal computer 102, cell phone 104, and/or server 106. In any event, such a computer-readable storage medium would preferably comprise instructions that, when executed for a system, cause the system to perform the method of synchronization of the present invention, thereby synchronizing related entries in different electronically stored directories.

In summary, such a program preferably includes the steps of storing first entries in the first of the directories, the first entries having first fields of different types of information, and each first field having a related stored confidence level that indicates a degree of confidence of the accuracy of said information. Given the processor 108 of FIG. 1, this function can be performed in combination with one of the electronic devices, for example, personal computer 102, cell phone 104, or server 106, with which it communicates. Further, the method of the present invention may include the step of storing second entries for a second one of the directories corresponding to the stored first entries in the first directory, the second entries having second fields for different types of information, each second field corresponding to a first field in a related first entry, and the second field also having a stored confidence level that indicates a degree of confidence of the accuracy of the information.

Thus, for example, if the first entries are stored in personal computer 102, the second entries may be stored in the directory of cell phone 104. A related one of these first and second entries may, for example, leave their respective entries of FIGS. 2 and 7, as described above. In the alternative, both directories may be stored in a common central location, but are accessed differently or as different directories.

The computer-readable storage media of the present invention may further include as part of its programming the step of determining when a change has been made to a field of an entry and the step of updating the corresponding field in the other directory when the confidence level for the changed field exceeds a threshold, as has been described in the illustrative examples set forth above.

Still further, the present invention may include the directory itself stored in any one of the electronic devices, for example, personal computer 102, cell phone 104, and server 106 of FIG. 1. Such a directory is for use with a system for synchronizing related entries in different electronically stored directories, this directory comprising a memory storing first entries for the directory, and these first entries having fields for different types of information, and each field having a related stored confidence level that indicates a degree of confidence in the accuracy of the data stored in the field.

In summarizing the embodiments of the invention disclosed above, the synchronization function of the present invention preferably first looks at a time stamp or hash entry to see if the entries are different. Note that the use of a time stamp or hash entry is an effective measure to allow rapid comparison to see which entries differ. The synchronization function of the present invention can compare all the entries upon each activation or selectively review many entries based, for example, on their time stamp information. When the synchronization function identifies records that have been separately modified, it takes a number of actions, as described above and summarized below.

Preferably, the synchronization function of the present invention compares the entries field by field to determine which fields differ between the two entries. For each field that differs across the multiple corresponding entries, the synchronization function of the present invention preferable performs a number of different actions. These actions may include selection of the most recent field, based on the time stamp of the entry, and comparison of the confidence levels of the most recent fields against one or two preferred thresholds. These thresholds may be considered to be an approval threshold and an acceptance threshold. If the confidence level equals or exceeds the approval threshold, all entries are updated to match the field value and confidence level from the most recent field. If the confidence level is less than the approval threshold but is greater than or equal to the acceptance threshold, steps can be taken to verify the results.

Steps to verify the results may include querying external data sources for corresponding entries, comparing low confidence entries with entries in other directories, analyzing the value of the field to determine if it has a format appropriate for that field, querying external data sources and other field values (referred to hereinafter as cross field validations) to determine if the field value represents a valid result for that field, and/or initiating an introduction with the user to get confirmation on the values being presented.

If the entry can be verified based on any of these steps, the synchronization function of the preferred embodiment updates all entries to match the field value from the most recent entry. The confidence level will be determined by the type or types of successful verification steps. For example, for each verification that is successful, the system of the present invention may, as one embodiment, add to the confidence level rating an amount equal to half the difference between the current confidence level and 100%.

If the confidence level is below the acceptance threshold, the synchronization function of the present invention in at least one embodiment could take steps to prevent the questionable doubt of a problem propagating. These steps may include updating a blank extra field in all entries with the most recent value, copying the field name into the extra field name area, and copying the confidence level as well. In the alternative, these steps may include initiating an interaction with the user to get confirmation on the values being presented. It is also possible in an embodiment of the invention to leave the result alone in the most recent record, without performing any update of the other electronic directories, and so notifying the user of the discrepancy.

For the fields that are the same across multiple corresponding entries, the synchronization function of the present invention preferably performs the following actions: setting the confidence level to the highest value among all the corresponding entries and, based on the results, determining these comparisons, and updating the directory entries, including the confidence level values as determined.

More specifically, the confidence level is set as a function of the values of the corresponding entries. One such function is to take the maximum value. If all the entries agree, it would be reasonable to increase the confidence level above that of each one of them to reflect the increased confidence that results from seeing the same value multiple times. One such function would be setting the confidence to a value of 1 minus the product of (1−Ci), where Ci is the confidence level of the ith entry.

One could also update a confidence level automatically based on user activities employing the stored data. For example, if the user receives an e-mail from an e-mail address with a low confidence rating, the confidence value can be increased. Or, if the user places a successful call to a number with a low confidence rating, the confidence level for that entry could be updated accordingly. Success here might require more than just the connection, but rather require that the call last a minimum duration to ensure that the confidence level is not increased based on a call that actually is a wrong number.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method for synchronizing related entries in different electronically stored directories, comprising:
storing first entries for a first one of said directories in a first memory, said first entries having first fields for different types of information, and each first field having a related stored confidence level indicating a degree of confidence of the accuracy of the data stored in each first field;
storing second entries for a second one of said directories in a second memory, said second entries corresponding to said stored first entries of said first directory, said second entries having second fields for different types of information, each second field corresponding to a first field in a related first entry and each second field having a stored confidence level indicating a degree of confidence of the accuracy of the data stored in each second field; and
determining when a change has been made to make a field entry that might otherwise be avoided when using a non-automated methodology; and
updating the corresponding field in the other directory when the confidence level for said field exceeds a threshold.

2. The method of claim 1, wherein said threshold is pre-assigned independent of any stored confidence level.

3. The method of claim 1, wherein said threshold is the confidence level of the field in the other directory to be changed.

4. A method of synchronizing related entries in different electronically stored directories, comprising the steps of:
receiving a proposed change in a field of one entry for one of said directories;
determining the confidence level of the proposed change, said confidence level indicating a degree of confidence of the accuracy of the data in said proposed change;
storing, in a memory device, said proposed change and confidence level for said field of said one entry in said one directory; and
synchronizing a corresponding field in at least one related entry in at least another one of said directories based on said confidence level for said one field.

5. The method of claim 4, wherein said step of determining includes setting said confidence level based on at least an apparatus used to create said proposed change in said field.

6. The method of claim 4, wherein said step of determining includes setting said confidence level based on at least a comparison of said proposed change to data in an external reference source.

7. The method of claim 4, wherein said step of determining includes setting said confidence level based on at least a comparison of said proposed change to data in the corresponding field of the another directory.

8. The method of claim 4, wherein said step of determining includes setting said confidence level based on at least a number of characters in said proposed change.

9. The method of claim 4, wherein said step of determining includes setting said confidence level based on at least the use of a spell-checking operation on said proposed change.

10. The method of claim 4, wherein said step of determining includes setting said confidence level based on at least the format appropriateness of the proposed change given a character of said field.

11. The method of claim 4, wherein said step of determining includes setting said confidence levels based on cross field validations.

12. The method of claim 4, wherein said step of determining includes setting said confidence level based on at least an interaction with a user.

13. The method of claim 4, wherein said step of synchronizing includes comparing said confidence level with an approval threshold.

14. The method of claim 13, wherein said step of synchronizing includes replacing the corresponding field when said confidence level is above said approval threshold.

15. The method of claim 13, wherein said step of synchronizing includes replacing the corresponding field with an entry when said confidence level is above said approval threshold and is higher than a confidence level of said replaced entry.

16. The method of claim 13, wherein said step of synchronizing includes verifying said proposed change when the confidence level is below said approval threshold and above an acceptance threshold that is lower than said approval threshold.

17. The method of claim 16, wherein said step of verifying includes resetting said confidence level based on at least the apparatus used to create said proposed change in said field.

18. The method of claim 16, wherein said step of verifying includes resetting said confidence level based on at least a comparison of said proposed change to data in an external reference source.

19. The method of claim 16, wherein said step of verifying includes resetting said confidence level based on at least a comparison of said proposed change to data in the corresponding field.

20. The method of claim 16, wherein said step of verifying includes resetting said confidence level based on at least a number of characters in said proposed change.

21. The method of claim 16, wherein said step of verifying includes resetting said confidence level based on at least the use of a spell-checking operation on said proposed change.

22. The method of claim 16, wherein said step of verifying includes resetting said confidence level based on at least the format appropriateness of the proposed change given a character of said field.

23. The method of claim 16, wherein said step of verifying includes resetting said confidence level based on at least an interaction with the user.

24. A method of synchronizing related entries in different electronically stored directories, comprising the steps of:
periodically comparing hash entry values of said related entries in said different directories;
identifying at least one changed field in one of said related entries in one of said directories when hash values for said related entries in said different directories are not the same;
identifying a most recently changed field in said related entries corresponding to said one changed field when said hash entry values are different for related entries;
identifying a confidence level stored in a memory for said identified most recent changed field, said confidence level indicating a degree of confidence of the accuracy of data stored in said most recent changed field; and
synchronizing said fields in said related entries corresponding to said one changed field in at least another one of said directories based on said confidence level for said one field.

25. The method of claim 24, wherein said step of periodically comparing hash entry values of said related entries in said different directories includes comparing hash entry values that are each based on at least the content of multiple fields of each said hash entry.

26. The method of claim 24, wherein the step of identifying a confidence level stored for said identified most recently changed field includes comparing time stamps for each said corresponding field to determine which has been most recently changed.

27. The method of claim 24, wherein said step of identifying at least one changed field in one of said related entries in one of said directories when hash values for said related entries in said different directories are not the same, includes identifying a first and a second changed field in one of said related entries in said directories.

28. The method of claim 27, wherein said first and second changed fields are in related entries in different directories.

29. The method of claim 27, wherein said step of identifying a confidence level stored for said identified most recent changed field includes identifying a confidence level for the most recent of each said first and second changed fields,
said step of identifying a confidence level stored for said identified most recent changed field includes identifying a confidence level stored for each said identified most recent first and second changed fields, and
said step of synchronizing said fields in said related entries corresponding to said one changed field in at least another of said directories based on said confidence level for said one field includes synchronizing said second changed fields in said related entries corresponding to said second changed fields in said directories based on said confidence level for said second changed field.

30. The method of claim 24, further including setting said confidence levels based on at least the apparatus used to create said proposed change in said field.

31. The method of claim 24, further including setting said confidence levels based on at least a comparison of content of said changed field to data in an external reference source.

32. The method of claim 24, further including setting said confidence levels based on at least a comparison of content of said changed field to data in a corresponding field in a related entry of the another directory.

33. The method of claim 24, further including setting said confidence levels based on at least the number of characters in said changed field.

34. The method of claim 24, further including setting said confidence levels based on at least the use of a spell-checking operation on said changed field.

35. The method of claim 24, further including setting said confidence levels based on at least the format appropriateness of the changed field given a character of said field.

36. The method of claim 24, wherein said step of determining includes setting said confidence levels based on cross field validations.

37. The method of claim 24, further including setting said confidence levels based on at least an interaction with a user.

38. A system for synchronizing related entries in different electronically stored directories, comprising:
a first memory storing first entries for a first one of said directories, said first entries having first fields for different types of information, and each first field having a related stored confidence level;
a second memory storing second entries for a second one of said directories corresponding to said stored first entries of said first directory, said second entries having second fields for different types of information, each second field corresponding to a first field in a related first entry and each second field having a stored confidence level; and
a processor connected to communicate with said first and second memories, and programmed to determine when a change has been made to a field of an entry and to update the corresponding field of any related entry in the other directory when the confidence level for said changed field exceeds a threshold.

39. A computer-readable storage medium comprising instructions that, when executed in a system, cause the system to perform a method of synchronizing related entries in different electronically stored directories, the method comprising the steps of:
storing first entries for a first one of said directories, said first entries having first fields for different types of information, and each first field having a related stored confidence level that indicates a degree of confidence of the accuracy of said information;
storing second entries for a second one of said directories corresponding to said stored first entries of said first directory, said second entries having second fields for different types of information, each second field corresponding to a first field in a related first entry and each second field having a stored confidence level that indicates a degree of confidence of the accuracy of said information; and
determining when a change has been made to a field of an entry; and
updating the corresponding field in the other directory when the confidence level for said field exceeds a threshold.

40. A directory for use with a system for synchronizing related entries in different electronically stored directories, said directory comprising a memory storing first entries for said directory, said first entries having fields for different types of information, and each field having a related stored confidence level that indicates a degree of confidence of the accuracy of the data stored in that field.
